(19) United States
(12) Patent Application Publication
(10) Pub. No.: US 2003/0189589 A1
(43) Pub. Date: Oct. 9, 2003

(54) Systems and methods for enhancing event quality

(75) Inventors: Frederick W. LeBlanc, Arvada, CO (US); Jeffery K. Buckwalter, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Air-Grid Networks, Inc., Littleton, CO

(21) Appl. No.: 10/309,653

(22) Filed: Dec. 3, 2002

Related U.S. Application Data
(60) Provisional application No. 60/364,826, filed on Mar. 15, 2002.

(51) Int. Cl. G06F 3/00; H04N 5/445; G06F 13/00; H04N 7/173; H04N 5/222; G09G 5/00

(52) U.S. Cl. 345/723; 348/722

(57) ABSTRACT

The present invention provides systems and methods for distributing content associated with an event venue in and about the event venue. The systems include one or more media inputs that comprise information associated with the event venue, an editing system communicably coupled to the one or more media inputs. The editing system can manipulate the information received from the one or more media inputs. Further, a distribution system is communicably coupled to the editing system, and a portable access device is communicably coupled to the distribution system. The methods involve a variety of approaches related to providing media streams to the portable access devices and for receiving and servicing requests from such portable access devices.

### CROSS-REFERENCES TO RELATED APPLICATIONS

This application claims priority to U.S. Provisional Patent Application No. 60/364,826, entitled “APPARATUS, SUSTEMS AND METHODS FOR PROVIDING LIVE AND/OR PRE-RECORDED MULTIMEDIA ACROSS A WIRELESS NETWORK TO PORTABLE DEVICES”, and filed on Mar. 15, 2002. The entirety of the aforementioned provisional patent application is incorporated herein by reference for all purposes

### BACKGROUND OF THE INVENTION

The present invention is related to video and/or audio distribution systems, and more particularly to systems and methods for providing access to audio and/or video information in relation to an ongoing event.

Today spectators pay considerable amounts of money to view sporting events even though the view of the event from inside the arena is not as good as that available through watching the event on television. Further, inside of the arena access to replays of key performances is often not available. In some cases, replays of sporting events are available in the arena on large screens. However, such replays are selected by someone other than the spectator and may not be of any interest to the spectator. Yet further, in the case of sporting events, the replays are often only of plays that are of particular significance to the home team. A great play by the opposing team is often not selected for replay.

Thus, for these and other reasons, there exists a need in the art for systems and methods to enhance a spectators experience at events.

### BRIEF SUMMARY OF THE INVENTION

Among other things, the present invention provides systems and methods for distributing live and pre-recorded video and audio, as well as other information in relation to ongoing events. In particular aspects, the invention relates to streaming live and pre-recorded video and audio across a wireless network in a sports entertainment environment. In such aspects, other services may also be included, such as to provide multi-media information related to an athlete or sports team member, and or to provide commerce over a wireless data communication network, and more particularly but not exclusively, to transactions involving goods and/or services, unrelated to the streaming video media, conducted via a portable wireless computing device, having connectivity to the wireless data communication network.

In some embodiments, the present invention provides a TCP-friendly transport protocol that can adaptively estimate the network bandwidth and smooth the sending rate. Further, in some cases, the present invention provides a global resource allocation control mechanism that maximizes the quality of audio and/or video streams delivered across fairly congested connections, where bits are allocated dynamically according to the media encoding distortion and network degradation. Yet further, with respect to multiple video objects, the present invention can provide a rate control scheme that uses such a multimedia streaming TCP-friendly protocol while minimizing the overall distortion under the constraint that the total rate for all objects is upper-bounded by a target bit rate. Additionally, some embodiments of the present invention minimize the end-to-end distortion for a given network traffic condition and picture quality requirement. As just some examples, the present invention can be applied to a number of other situations and applications including, but not limited to, a live spectator sports stadium, race track, ski course, concert, or other entertainment environment.

Various embodiments of the present invention provide multi-media networks implemented in event venues. Such multi-media networks include one or more media inputs that provide information associated with the event venue. Thus, for example, such media inputs can be a video presentation of a sporting contest, concert or other activity occurring in the arena. An editing system is communicably coupled to the one or more media inputs such that the editing system can manipulate the information received from the one or more media inputs. Thus, for example, twenty or more video feeds may be received. The editing system may select five of the twenty feeds for live distribution, and use portions of the twenty feeds to select and store replay feeds. A distribution system is communicably coupled to the editing system, and a portable access device communicably coupled to the distribution system.

Other embodiments provide methods for distributing content to an event venue. The methods include receiving a content stream, formatting the content stream into a first accessible format and a second accessible format, and providing access to the first and the second accessible formats via a portable access device maintained local to the event venue.

Yet other embodiments provide methods for distributing content in a sporting arena the methods include receiving content from a plurality of sources in the sporting arena, and editing at least one of the plurality of sources. From this, a live stream and a replay stream are created. Selections associated with the live stream and the replay stream are provided on a portable access device. An indication of the replay stream is received and the replay stream is provided to the portable access device. In some cases, the methods further include providing a shopping interface via the portable access device such that a user can order goods available at the sporting arena. In other cases, the method further includes predicting which content from the plurality of sources to provide as a multicast verses a unicast to the portable access device. Such a prediction can be based at least in part on a quantity of selections received from a plurality of portable access devices.

This summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a system in accordance with the present invention;

FIGS. 2-3 are views of an editing facility useful in relation to the present invention;

FIG. 4 is a flow diagram of a method in accordance with the present invention;

FIG. 5 is an elevation view of a venue indicating a network access point;

FIG. 6 is an architectural sketch of a typical set of component structure in accordance with the principles of the invention; and

FIGS. 7-13 are screen shots of webpages used in relation to the present invention.

### DETAILED DESCRIPTION OF THE INVENTION

The present invention includes systems, methods and devices for transmitting, receiving and utilizing multi-media (e.g., audio, video, text, graphics, and the like). Such an invention is applicable to a variety of circumstances and situations. As disclosed herein, the systems, methods and devices are described in relation to multi-media applications in a sporting arena. However, from the disclosure provided herein, one of ordinary skill in the art will recognize a myriad of other applications and/or implementations of the present invention.

A spectator's singular physical position in an arena or event venue precludes that individual from instantly examining a large number of different views. In part to overcome this limit, various embodiments of the present invention provide a portable access device to a spectator that is capable of accessing multi-angle views, audio commentary, and/or data integral to enhancing the spectator's experience. Streaming multi-angle live and replay video and audio media adds engaging motion and sound to the spectator's experience via the portable access device. This additional information increases a spectator's understanding and interactivity with an ongoing experience or event. In some cases, a tablet personal computer (TPC) is used as the portable access device.

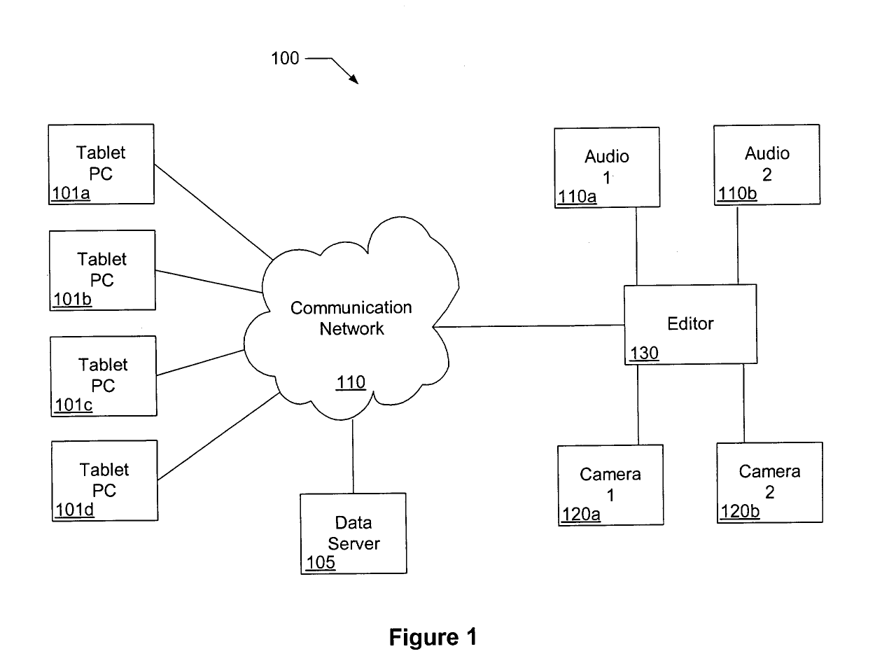

Referring to FIG. 1, a block diagram of a distribution system 100 in accordance with embodiments of the present invention is depicted. As depicted, distribution system 100 includes a number of portable access devices 101. In some cases, such portable access devices are TPCs. Portable access devices 101 are in communication with an editor 130 and a data server 105 via a communication network 110. In some embodiments, communication network 110 is a wireless communication network, or a combination of communication networks that include a wireless component. For example, communication network 110 can be the Internet provided by hubs and routers as known in the art, along with a wireless LAN providing interaction with portable access devices 101. Delta cerver 105 can support various web pages related to the present invention, and provide data related to the ongoing event.

Editor 130 can be a production facility for receiving various feeds from cameras 120 and audio sources 110 in relation to the ongoing event. These feeds can be edited and prerecorded segments of the feeds made available for access by the portable access devices 101. In some cases, cameras 120 and audio sources 110 are those provided at a venue for transmitting the event to a television network.

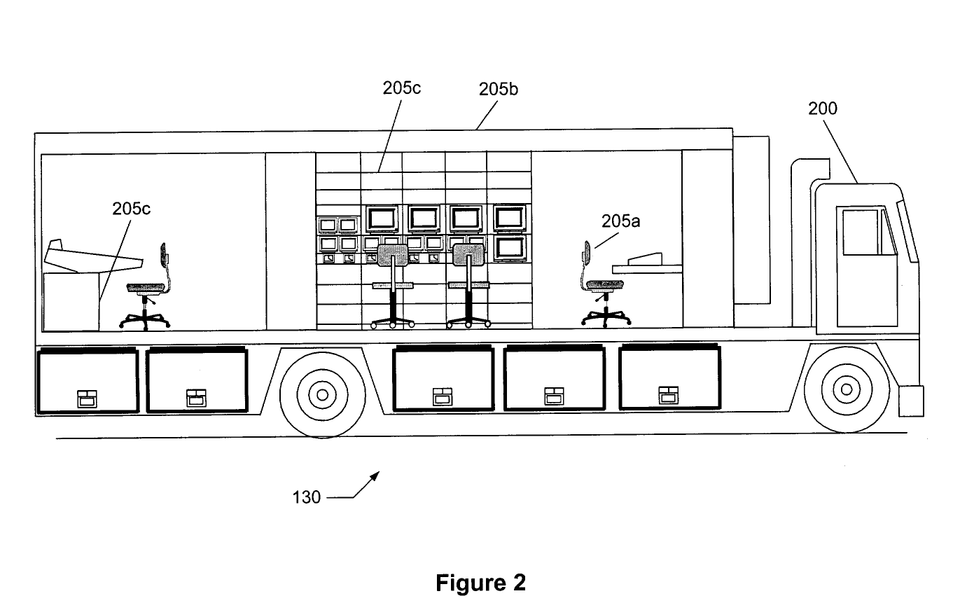

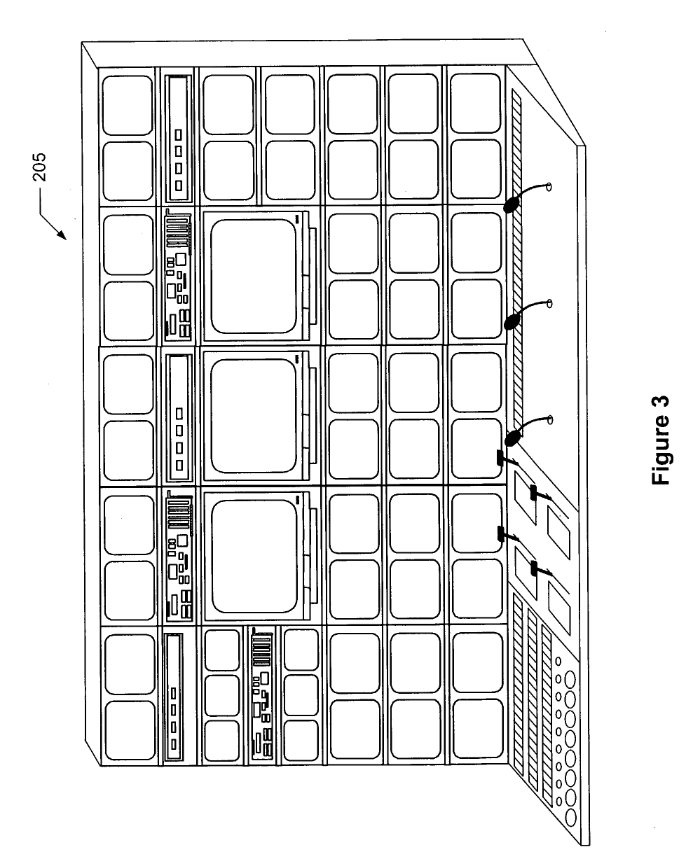

Referring to FIG. 2, a diagram of an embodiment of editor 130 is provided. As illustrated, editor 130 can be implemented in a production truck 200 and provide various workstations 205 for receiving video and/or audio feeds, editing the feeds, and producing accessible portions of the feeds. FIG. 3 includes a more detailed view of a workstation 205.

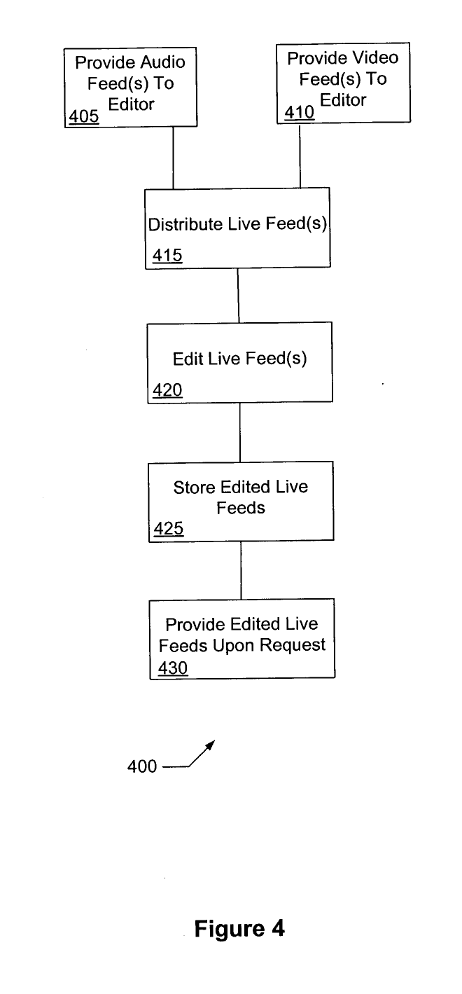

Referring to FIG. 4, a flow diagram 400 illustrates a method in accordance with the present invention. Following flow diagram 400, audio and/or video feeds are provided to the editor (block 405, 410). In some embodiments, the audio and video feeds can be provided from a number of different angles and/or from a number of different commentators. The various angles can provide different vantage points. The editor distributes one or more of the received feeds thus allowing a spectator to select between the various live views via a portable access device (block 415). Thus, a spectator at a football game that is seated on the fifty yard line can enjoy a view from the end zone when a field goal is being kicked, or a spectator in the end zone can enjoy the view from the fifty yard line when the activity is ongoing away from the end zone. In one particular embodiment, the spectator can select between the various live feeds much as a production director would in selecting between the various feeds in producing a televised event.

In addition, the Editor edits the live feeds and produces various replay segments (block 420). The various replay segments can then be stored on a server in the editor that can be accessed via the portable distribution devices (block 425). In simple operation, the various replay segments are listed on a web page accessible via the portable distribution device. A spectator selects one of the replay segments using a browser, and the replay segment is streamed to the spectator's portable distribution device (block 430). Thus, the spectator is able to control which of various replay segments are viewed, and when to view the replay segments.

Streaming to wireless portable access devices, such as TPCs allows timely, multi-angle dynamic content to be seen by a larger audience, helping to cost effectively disseminate information, to address new markets, and to intensify the spectator's understanding and enjoyment of an event. From a potentially large number of live video camera and audio feeds often used during, for example, a sporting event, this invention provides for capturing and editing a select reduced number of live, multi-angle video camera information, and the streaming of that media wirelessly, to a portable access device held by a spectator. This new capability allows the spectator to have real-time and on-demand access to audio, video, and multimedia content via a wireless, portable connection with a local intranet. After camera angle selection and editing, the resulting media can be streamed and transmitted by a specialized media server application using, in some embodiments, a broadband wireless network. The signal is processed by a portable access device with a video and audio output capability, with the a selection of multiple media stratums available to be played back by a client player application, as it is received. In some case, no residual copy of the content remains on the portable access device. Therefore, the recipient can neither alter nor redistribute the content in an unauthorized manner. This can be important where copyrights are to be protected. Further, in some cases, the portable access device is only operable within an arena or other venue in which the event is ongoing. Again, this provides an ability to protect copyrights, and to protect copyrights sold to television stations. Other means to prevent pirating or legal use of streaming video includes applying digital rights management techniques in the digital media files and streams, then having appropriate security means at the client player. In some cases, the client player is a software program on a portable access device, used to render the audio and video multi camera angles and show pre-recorded video to an authorized user.

Streaming media and broadband wireless technology enables the transmission of multiple channels, or streams of real-time or on-demand access to audio, video, and multimedia content via the Internet or an intranet. Streaming technology enables the near real-time transmission of events recorded in video and/or audio, as they happen-sometimes called “Live-Live,” and referred to as Web casting. Streaming technology also makes it possible to conveniently distribute pre-recorded/pre-edited media on-demand. In other words, media that is stored and published on the Web in streaming formats can be made available for access at any time. Streaming media is transmitted by a media server application, and is processed and played back by a client player application, as it is received.

A client application, known as player, can start playing back streaming media as soon as enough data has been received-without having to wait for the entire file to have arrived. As data is transferred, it is temporarily stored in a buffer until enough data has accumulated to be properly assembled into the next sequence of the media stream. When streaming technology was first available, the ability to begin playback before the entire file had been transferred was a distinct advantage. Newer pseudo-streaming techniques, such as progressive download, allow some other formats to begin to play before file download is completed. A streaming architecture is an interdependent system comprised of a variety of components that all work together to perform certain functions. Streaming media architectures are comprised of encoding and transmission methods, server software, and players (client software).

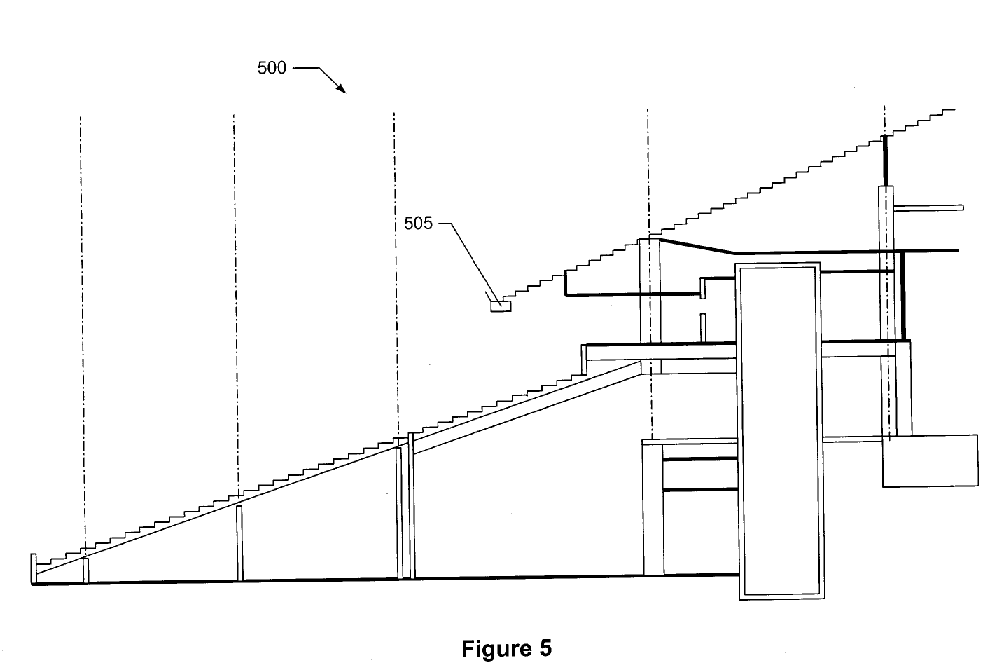

In some cases, communication network 110 is a wireless local-area network (WLAN) that uses Radio Frequency (RF) technology to transmit and receive data over the air, providing all the features and benefits of traditional LAN technologies but without the limitations of a cable. A WLAN is a flexible data communications system implemented as an extension to, or as an alternative for, a wired LAN. Thus, wireless LANs combine data connectivity with user mobility. Most WLANs today use the 2.4-gigahertz (GHz) frequency band, but the 5 GHz band is rapidly emerging. Two main types of hardware form the basis of the wireless network: 1.) Wireless Network Interface Transceiver Cards (WNITCs), and 2.) Access Points. In a wireless LAN, WNITCs provide the interface between the client's computing system and the wireless access point, to create a transparent connection to the network. In some cases, TPCs are used as portable access devices, while in other cases, a Personal Digital Assistant (PDA), a sub-notebook computer, a laptop computer, a web enabled cell phone, and the like can be used. The access point (AP) is the wireless equivalent of a hub. An AP is typically connected to the wired LAN backbone through a standard Ethernet cable, and communicates with wireless devices by means of an antenna (which can be mounted internally or externally to the AP). A wireless access point maintains the connections of its clients (computing system) across its area of coverage permitting or denying specific traffic or clients from communicating through it. Referring to FIG. 5, a elevation view of an arena 500 illustrates one potential location 505 of such an access point.

In particular implementations, IEEE 802.11 standard is used to implement a WLAN. Further, in various implementations, a LAN application, network operating system or protocol, including TCP/IP, is run on IEEE 802.11 compliant WLANs.

To date the Institute of Electrical and Electronics Engineers (IEEE) have developed three specifications in the Wireless LAN (WLAN) 802.11 family: 802.11, 802.11a, and 802.11b. All three of these specifications use Carrier Sense Multiple Access with Collision Detection (CSMA/CD), as the path-sharing protocol. If a source station has a data packet to send, the station checks the system to see if the path medium is busy. If the medium is not busy, the packet is sent; if the medium is busy, the station waits until the first moment that the medium becomes clear. Testing is done repeatedly by the source via a short test message called Ready to Send (RTS). The data packet is not transmitted until the destination station returns a confirmation message called Clear to Send (CTS). If two stations send at exactly the same time, CSMA/CD prevents the loss of data that might otherwise occur and provides a system for retrying.

The 802.11 and 802.11b specifications apply to Wireless LANs, and operate at frequencies in the 2.4 GHz bandwidth of the radio spectrum. Data speeds are generally 1 Mbps or 2 Mbps for 802.11, and 11, 5.5, 2, and 1 Mbps for 802.11b. The 802.11b standard is also backwards compatible with 802.11. The modulation used in 802.11 has historically been Phase-Shift Keying (PSK). The modulation method selected for 802.11b is known as complementary Direct Sequence Spread Spectrum (DSSS) using Complementary Code Keying (CCK), which allows higher data speeds and is less susceptible to multi-path propagation interference. The 802.11a specification operates at radio frequencies between 5.15 and 5.825 GHz. A modulation scheme known as Orthogonal Frequency-Division Multiplexing (OFDM) makes data speeds as high as 54 Mbps possible, or in some cases even high speeds may be possible. Depending on the distance from the Access Point and network load, 802.11a products can use auto-rate scaling to decrease data rates down from 54 Mbps.

In some instances, Multicast and non-Multicast (unicast or broadcast) IP are used. Such an approach provides an elegant extension of the Internet Protocol, routing each packet by destination and/or source address.

Multicast IP can be a way distribute several types of data to a divergent base of users from 3-way collaborative conferences to live audio transmissions with thousands of clients. Although Multicast IP's flexibility and adaptability does allow for digital voice, video and distribution in various combinations, it relies upon random, non-deterministic, inherently unreliable packet-switched transmission.

The strength of circuit-switched media, whether POTS (“plain-old telephone service”) or ISDN video, is in their single application dedication. When a switched circuit is operating, no other application can infringe upon its allocated bandwidth. Conversely, when transmitting digitized content over a packet-switched network, such as an Intranet or the Internet, there is no guarantee of packet sequence, jitter-free reception, data integrity, packet arrival time or even that the packet will arrive. This can cause problems ranging from minor, momentary interruptions of multicast video to serious disruptions that prevent the client application from displaying content.

Even in the case of a private intranet wireless and wired network contained within a sports environment, significant challenges arise that can make multiple live and pre-recorded audio-video streaming to a plurality of portable devices difficult. Since this described sports stadium-based wireless intranet results in being a shared environment that does not automatically manage the utilization of its resources, the portable client computing systems are expected to be cooperative by reacting to congestion properly and promptly. As a result, overall utilization of the network could remain high while each flow obtains a fair share of resources.

The available bandwidth in a general purpose network, such as the public Internet fluctuates frequently in nature. Most conventional streaming applications are unable to perform quality adaptation as available bandwidth changes, especially quality adaptation among multiple streams. Thus, in some cases, these conventional streaming applications do not make effective use of the bandwidth.

Various schemes for QoS management including, but not limited to, resource reservation, priority mechanism, and application level control can be used in conjunction with various embodiments of the present invention. The following documents describe a variety of such QoS management schemes that can be modified for use in relation to the present invention. The entirety of each of the documents is incorporated herein by reference for all purposes.

(1) R. Braden, L. Zhang, S. Berson et al, “Resource ReSerVation Protocol (RSVP)—Version 1 Functional Specification”, RFC 2205, September 1997 (“hereinafter, “Braden et al.”);

(2) R. Rejaie, M. Handley, and D. Estrin, “Quality adaptation for congestion controlled video playback over the Internet”, Proceedings of SIGCOM 99 (“hereinafter, “Rejaie et al. [SIGCOM]”);

(3) R. Rejaie, M. Handley, and D. Estrin, “An end-to-end rate-based congestion control mechanism for realtime streams in the Internet”, Proceedings of INFOCOMM99, 1999 (“hereinafter, “Rejaie et al. [INFOCOMM]”);

(4) T. Chiang and Y. Q. Zhang, “A new rate control scheme using quadratic rate-distortion modeling”, IEEE Trans. Circuits Syst. Video Technol., February. 1997 (“hereinafter, “Chiang et al.”);

(5) D. Sisalem and H. Schulztinne, “The loss-delay based adjusted algorithm: A TCP-friendly adaptation scheme”, Proceedings of NOSSDAV'98, 1998 (“hereinafter, “Sisalem et al.”);

(6) J. Padhye, V. Firoiu, D. Towsley and J. Kurose, “Modeling TCP throughput: A simple model and its empirical validation”, Proceedings of SIGCOMM'98, 1998 (“hereinafter, “Padhye et al.”);

(7) O. Verscheure, P. Frossard and M. Hamdi, “MPEG-2 video services over packet networks: joint effect of encoding rate and data loss on user-oriented QoS”, Proceedings of NOSSDAV 98, 1998 (“hereinafter, “Verscheure et al.”);

(8) A. Vetro, H. F. Sun and Y. Wang. “MPEG-4 rate control for multiple video objects”. IEEE Trans. Circuits Syst. Video Technol., February 1999 (“hereinafter, “Vetro et al.”); and

(9) M. Eckert and J. I. Ronda. “Bit-rate allocation in multi-object video coding”. ISO/IEC JTC 1/SC29/WG 11 MPEG98/m3757, Dublin, Ireland (“hereinafter, “Eckert et al.”).

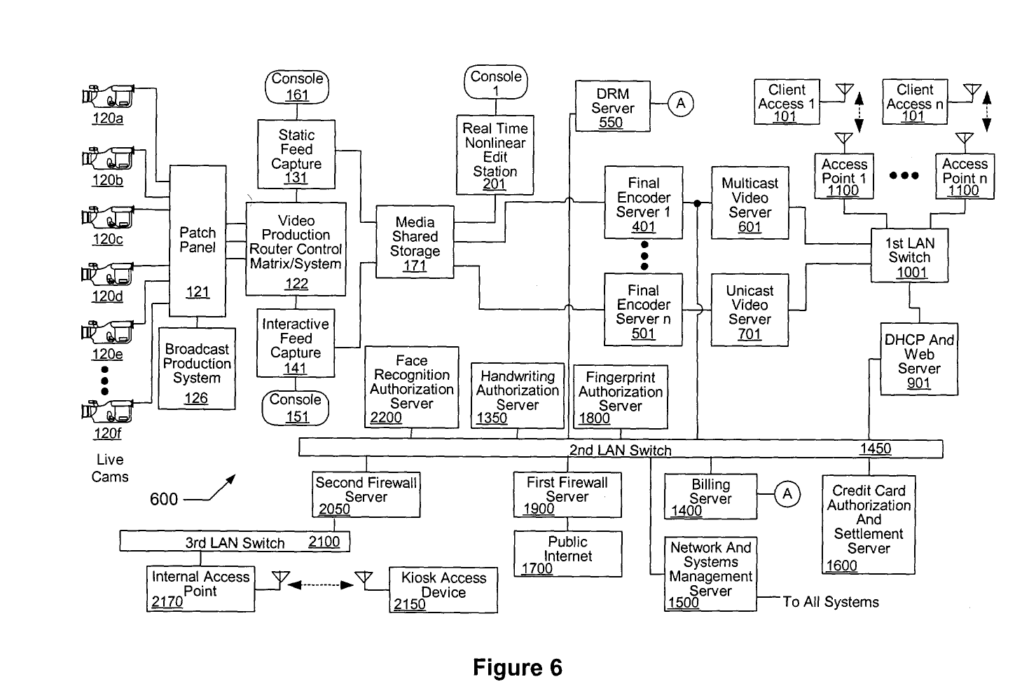

Referring to FIG. 6, a block diagram 600 illustrates the various components used in one embodiment of the present invention. A description of the various components of the embodiment is provided, followed by a description of the functional modes. The functionality of the software and hardware pertinent to the invention is described at several levels including at the interface level (what the end user sees and experiences) and at the action level (software and hardware interactions involving digital messages, content, and data). Based on the description provided herein, a software engineer of ordinary skill in the art would be able to program the functions described here using common programming languages and tools such as C, C++ and Java programming languages, and Microsoft Foundation Classes (MFC), and other tools and development systems for other operating systems such as VxWorks and Linux. Details of the software architecture are given when it is deemed to aid in the complete disclosure of the system.

Block diagram 600 includes one or more existing or new cameras 120 are used to televise an event, such as a sporting event. In some cases, such cameras are provided by a broadcast network company or the sports stadium owner for internal use. The audio and video output signal for one or more cameras 120 and/or audio source 110 are generally carried over a cable, with an input to a patch panel 121 consisting of a splitter function that routes the camera signal both to the existing broadcast video production system 122 and to one or more audio video capture encoder systems including consoles 151, 161 that can be integrated as part of a workstation 205. The broadcast video production system 122 may be owned by a broadcast network company or a sports stadium owner.

These systems can be deployed as a set of video production equipment located within a remote truck, brought temporarily to the stadium's truck bay area. Generally separate cameras 120 are used by the broadcast network company and the owner, with camera signals sent to separate broadcast video production systems 126 owned and operated by each separately. Patch panel and splitter 121 function allows camera signal access of all cameras. Patch panel and splitter 121 may also provide signal amplification and isolation functions, by using a video signal distribution amplifier, in cases where significant physical distance cable runs are involved between the patch panel and other broadcast video production facilities. One example of a video distribution amplifier known to the inventors is the model 8800 Utility Video distribution amplifier, made by the Grass Valley Group of Nevada City, Calif. Patch panel and splitter 121 provides a means to extract the multiple camera signals and forward those signals to a media control matrix system 122.

Media control matrix system 122 provides video and/or audio signal routing and selection from a large number of video and/or audio input signals and signal types for further processing in a common format. Exemplary functions include mixing and matching various video camera signal feed types such as AES/EBU digital audio, standard definition (SD) and high definition (HD) digital video, switching SMPTE time code, output monitoring and port data for remote machine control and quality control monitoring. Other support functions include the configuration of logical cross-points that can be selectively assigned to ensure that input signals are only routed to appropriate output destinations. These logical matrices can be tied to a single control level for simultaneous switching (such as audio/video, video/key, or R/G/B). An example of a commercial products that together perform these functions is grass Valley Group's Concerto Series of compact routing matrix, coupled with the Encore routing control system.

Media control matrix system 122 provides a mechanism for a video production director to select a subset of video camera signal streams from a relatively large number of video camera signals. The exact choice of which camera signal streams to further process is a human art, highly dependent upon the events underway during the sporting event, but are similar to the video production processes performed routinely at any major league sports events. Generally video production crews today select a single primary video output channel for their production delivery process, which is typically shown on an ordinary television that cannot display multiple video channels simultaneously. In contrast, the present invention can involve the selection of one or more views to be streamed simultaneously.

In embodiments of the present invention, multiple live video streams are presented to a spectator, along with the dynamic creation of multiple camera angle replay video clips of key sports event action. Thus the production crew's responsibility is to select among the 15 to 20 camera feeds, the most appropriate video signal(s) for further processing. The cross matrix function is important since it may be important for a particular video feed to be routed to multiple video output ports. For example a particular camera angle feed might be used both for live streaming to a video Internet server, as well as to be input to an interactive video capture system for generating video clips for later use as instant re-play downloadable clips.

In one particular embodiment, the video signals from four live camera angles are selected from perhaps 15 to 40 camera feeds. A video director individual is responsible for selecting the appropriate video channels using a keyboard and button set to carry out the selections. In another embodiment, a tally is collected from a subscriber population using a web browser and webpage designed for this purpose, along with two-way wireless local area network radio communication, and if sufficient votes are found, users may request a given camera feed source.

An example of this embodiment is in auto racing where a large number of racecars camera signal feeds are all routed to media control matrix system 122. Using the architecture further described below, the director who operates media control matrix system 122, learns of the spectators' strong interest in viewing a particular camera angle feed from a large number of possible camera angle feeds. The director may then decide to honor the spectators' request by pressing the appropriate video feed selection buttons in media control matrix system 122, causing that particular race car's camera angle signal to be displayed to the spectators who have requested that particular camera feed source.

An example would be to view the number two cars' camera angle, as it pans forward, catching the number one racecar in view. An example of a media control matrix system 122 for use in this application is the Grass Valley model Encode 7000. Media control matrix system 122 consists of a collection of input video (note all references to video also imply an audio channel within or associated with the video channel) ports and output ports that are connected by manual switch buttons by the director on a console panel as part of the system.

Continuing with the description of video processing steps, a static video/audio feed capture server 131 is coupled with media control matrix system 122 and a media shared storage system 171. Static video/audio feed capture server 131 ingests a selected video signal from an output port from media control matrix system 122 and performs video signal capture, or analog to digital conversion if desired, and transcoding to a video format suitable for general purpose editing and further processing, using, for example the MPEG2 format. Other functions that may optionally be performed, depending upon the quality of the camera feed signal include median noise filtering, inverse telecine, de-interlacing, cropping, blur, noise reduction and sharpening. An example of a product that presently performs these functions is the Grass Valley model PVS 1000. Setup and operation of the static video/audio is provided to a video technician via a computer console 151, 161 and keyboard.

Interactive feed capture server 141 is coupled with media control matrix system 122 and ingests a selected analog or digital camera video signal for generating digital video clip replays of the current sports action, and outputs the results using MPEG4 format. After the operator has identified a desired video clip for re-play purposes, the resulting new video asset is sent onto the media shared storage system 171. Certain functions of the interactive feed capture server 141 are particularly relevant in a sports setting in order to accurately prepare replay clips on the fly and have those video assets available for near-instant access via the wireless network. The auto retro mark function allows the video operator to automatically capture a video segment before a mark-in point. This function ensures that the key event is not missed even if the video operator's response time is a second or two too late. A retro mark function provides the operator with the ability to specify any amount of time to capture automatically prior to a mark-in point. This function is important in creating video clips for fast-moving sports games wherein it is difficult for the operator predict when a homerun will occur, or a touchdown, or a hockey puck goal is made. The video operator can view the video feed as it is being recorded to disk, and to mark-in and mark-out the video clip boundaries on the fly, and to play those clips straight to the playout portion of this invention, being coupled with media shared storage system 171, further discussed below. One such product known to accomplish these functions is Grass Valley Group's FeedClip interactive feed capture server system.

A real time nonlinear editing station server 201 ingests digital video from the media shared storage system 171, and outputs its results back to the media shared storage system 171 as a separate asset. Important functions to the present invention here include the nonlinear timeline that supports the edit inclusion of other clips, voice-overs, trimming, L-cuts and knife editing of clips, adding real-time transition effects, preview, three-point edits, audio scrubbing and audio fade controls. This system provides the means, for example, for the operator to insert advertisements, audio commentary, general or specific purpose warnings and alert messages. To take advantage of potential advertising revenues, video clips may be generated in the interactive feed server 201, sent to the media shared storage system 171, then onto the static feed capture system 131 for further editing to include one or more advertisement.

Media shared storage system 171 is a server computing system optimized for storing large amounts of digital video files. In one embodiment it is comprised of a fiber channel RAID disk Storage Area Network (SAN) in communication with a redundant fiber channel switch, and a group of storage data server computing systems. The switch allows video data to flow among storage data servers and the RAID SAN at very high speeds, on the order of 80 mbps. Other embodiments omit the SAN if additional storage is not desired. One product meeting these functions needs is Grass Valley Group's model PVS 1044.

A first final encoder server 401 takes the MPEG2 live video assets in MPEG2 format stored in the media shared storage system 171 and transcodes the result into an MPEG4 stream in real time. Where the amount of CPU processing time is relatively high for MPEG format conversion, a separate server can be utilized.

The results are output to a multicast video server 601. Multicast video server 601 is used to stream live video into an intranet within the sports stadium via a local area network switch 1001. Multicasting provides a highly efficient way to broadcast or push video data out to users without having a significant network and capacity load on the servers. In a particular embodiment four live video streams are multicast out to portable access devices 101 for subscriber viewing.

The second final encoder server 501 takes the MPEG2 replay video assets in MPEG2 format stored in media shared storage system 171 and transcodes the result into an MPEG4 format, then stores the results on a unicast video server 701. The unicast server 701 is coupled with a first local area network switch 1001 using, preferably, the giga-E. format on a fiber connection. Using this first stadium internal local area network, web protocols such as http, RTP, and RCTP are used to stream video content from the unicast server as requested by browser client software contained on a portable access device 101.

The first local area network switch 1001, which comprises a first local area network, is coupled with IEEE 802.11 access points 1100 over a Gig-Ethernet or 10/100 MBPS network. The access points 1100 can use the IEEE 802.11a specification protocol in communication with the portable access device 101, in order to carry the web protocols and signals between various servers and the Internet browser software, in communication with the first local area network.

Portable access device 101 can include an input means, a touch sensitive display, 32 bit sound card with stereo output capability, at least one and a PCMCIA CardBus 32 bit slots, either an Intel or Transmeta CPU with at least 700 mHz speed, running either Microsoft Windows 2000 or XP, a battery sufficient for a three hour viewing period, a docking interface with an Ethernet connection. One of the two PCMCIA slots must contain an IEEE 802.11 transceiver card, preferably using IEEE 802.11A protocol. Portable access device 101 uses the transceiver card to provide a wireless local area network communications channel between the access point 1100 and the computing elements within the portable access device 101.

A dynamic host configuration protocol (DHCP) server and world wide web server 901 is coupled with the first local area network (LAN) switch 1001, and provides Internet protocol address allocation services to portable access devices 101 that are properly authorized, on the first stadium network.

There are two user signup cases considered herein. In the first case the user completes a financial transaction at a kiosk, then receives a portable access device 101, and completes end-user authorization at the same location and time. In the second case the user already has a portable access device 101, but will need to pay for the actual video service via an online electronic transaction. In either case the DHCP server and web server 901 provide standard http and https web traffic support to the portable access devices 101, allowing navigation through the various product's services. The web server 901 provides the host website for a open enrollment basic and a secured services website. The open enrollment basic website consists of an unsecured site with links and processes to establish the video service using an online authentication method in the case where payment has previously been secured, or a credit or debit card capture and authorization process that leads to online authentication. Upon successful authorization, access is then granted and the user's browser is redirected, taking the user to an https, or secure sockets layer website, used to provide the primary services and to complete the financial transaction.

Thus a potential user may be given a rental portable access device 101 without first capturing credit/debit card charging information and authorization. Alternatively a user who has completed a financial transaction for the device rental and service may receive authorization to proceed directly to the secured services website.

Referring to FIG. 6 again and elaborating on the first case, a spectator who is a potential subscriber provides his/her credit/debit card to a kiosk vendor, typically located at the sports stadium, and requests a rental of a wireless portable access device 101 and service for the current game about to begin. In a particular embodiment, the portable access device 101 is a portable TPC that contains a wireless data communications card, compliant with the IEEE wireless local area network standard, and running a common operating system such as the Microsoft Windows Windows 2000, or XP operating system.

In a particular embodiment the TPC could have passed various tests defined further in current Microsoft Hardware Compatibility Tests (HCTs). Other embodiments may include web tablets, laptop computers, subnote computers and personal digital assistants. In any case the devices may have a IEEE 802.x wireless transceiver card compatible with the unlicensed radio frequency spectrum and protocols used by the rest of the wireless network used in the sports stadium.

Using currently available point of sale credit/debit card processing means, the kiosk vendor validates that the potential subscriber's offered credit or debit card has a sufficient line of credit to pay for the actual cost of the access device, could it be lost, stolen or damaged. In addition an insurance policy may be offered to the user, to cover for the loss, theft, or damage to the portable access device 101. Assuming a sufficient line of credit exists, the kiosk vendor may optionally offer the potential subscriber an insurance policy that covers the expenses associated with loss or damage of the portable access device 101, for an additional fee.

After the potential subscriber agrees to the terms of the rental and a service agreement that defines the terms of use, the kiosk vendor completes the transaction and enters a record of the transaction using a security-protected software application that captures the transaction information, also called a subscriber enrollment application provided to the kiosk vendor for this purpose, running on a kiosk access device 2150.

In a particular embodiment the enrollment application software is running on a kiosk access device 2150 comprised of a TPC with an anti-theft attachment to a physically secure point within the kiosk's protected area. The enrollment application is accessed by a satisfactory authentication method, such as a logon identification and security password. The password is pre-established for each kiosk employee. The kiosk access device 2150 establishes communication via a IEEE 802.11 transceiver card coupled to the kiosk access device 2150 via means of a PCMCIA card slot, or other means, such as internal construction.

The transceiver card provides communication on a separate air interface network to an internal access point 2170. The internal access point 2170 translates the radio frequency communications to a third local area network and switch 2100. The third LAN switch provides a separate network to a second firewall server 2050, that provides security and isolation to the second LAN switch and network 1450. The second LAN and switch 1450 provides communications to a number of internal systems for operational support, including account management, fault management, security management, performance management and configuration management.

In one embodiment, security authentication may be employed using various biometric security authorization technology, such as a fingerprint recording and recognition system via fingerprint authentication server 1800, or a face recognition system via face recognition server 2200 or handwriting authentication server 1350. One example of a fingerprint recording and recognition system is the DigitalPersona “U.are.U” product line, which provides sensors, recording and recognition software, and software development toolkits with well-defined application programming interfaces.

The TPC access device includes a digitization capability inclusive of the TPC specification that enables a user to sign for a financial transaction, and provide proof of valid signature. At a kiosk of similar facility, after a user has provided sufficient payment for a given transaction, the user's signature is captured on a kiosk access device 2150 and communicated to the handwriting authentication server 1350, via the internal access point 2170, third KAN switch 2100, second firewall server 2050, and second LAN switch 1450.

As an alternative embodiment, a facial recognition system is employed into this system using the fact that the kiosk access device 2150 and the portable access device 101, using the TPC specification for example, include a digital camera for face recognition capture. One example of a software product that can be incorporated herein is the face software product line, including for example, the PASSmobile”, by Visage Technology Inc., of Littleton, Mass. The vendor's “FaceTools” software development kit provides well-defined application programming interfaces for integration into the present invention. At the time of the financial transaction at the kiosk, a picture image is taken by the kiosk access device 2150, and stored, along with other relevant information such as the user's name, portable access device 101 MAC address, in the face recognition authentication server 2200. User information such as the user's name and account information, profile or preference information, is captured during the point of sale/rental and stored in the billing server 1400. The billing server 1400 now establishes that a given MAC address, associated with a given portable access device 101, handwriting signature, and/or name/password, and/or face recognition image, are valid for a given level of service.

Once the potential subscriber's financial transaction is successfully completed the kiosk vendor provides the subscriber with a rented portable wireless access device. After the subscriber (i.e., a paying user) powers on the portable access device 101 the access point 1100 and the IEEE transceiver card contained within the portable access device 101 request an initial login IP address from the DHCP server 701. The DHCP server 901 sends a message to the billing server to validate the portable access device's 101 MAC address, and provides an IP address for the portable access device 101. An Internet browser software program is now made operational on the portable access device 101 and displays a welcome website web page or screen.

The introduction screen will in fact be automatically displayed after the portable access device's 101 operating system is booted up, in the form of an ordinary Internet web browser (probably the latest version of Microsoft's Internet Explorer) that displays a default unsecure webpage. This webpage or screen can be a friendly, open-enrollment Air-Grid home-page website having customization for the local stadium's name and logo.

Authorized, subscribing users can be required to pass a security check in order to gain access to the secured, premium video website. The security check can be any of the forms of a hand written signature, face picture image capture, and/or name and password information. In the case of a handwritten signature, the subscriber provides by signing his/her name on the portable access device 101, if the device is a TPC or other wise has means to accept a signature. In this case a subscriber is expected to enter their signed name in cursive, and/or to enter his/her password via a stylus pointer and a cursive signature, or password text entry via a pop-up alpha-numeric touch keypad provided by the client access device portable access device 101.

The password can be a unique auto-generated text string previously provided to the subscriber during the purchase/lease point of sale of the portable access device 101 at the kiosk, and given only to the credit card holder responsible for the portable access device 101. On-line help and customer care phone-in information will also be displayed. Having preferably up to five chances to enter the security text properly, upon successful authorization, the user is taken to a secure SSL v3.0 webpage page, for example, “Live Video”, that allows the user to select the service for which he/she has purchased. It could also be possible for repeat-use subscribers to have saved various personal configuration preferences for the device.

This is the main secure ‘homepage’ for the service offering. From this point onward all webpages can be SSL-secured. Of all the potentially available local camera feeds, an AirGrid video production director will decide which of four (or so) live video and audio feeds will be streamed to users. The access device will display up to four live video streams to the subscriber, depending upon its' CPU capability, display capabilities, etc. A static, simplistic example of what a live video screen might look like is as follows:

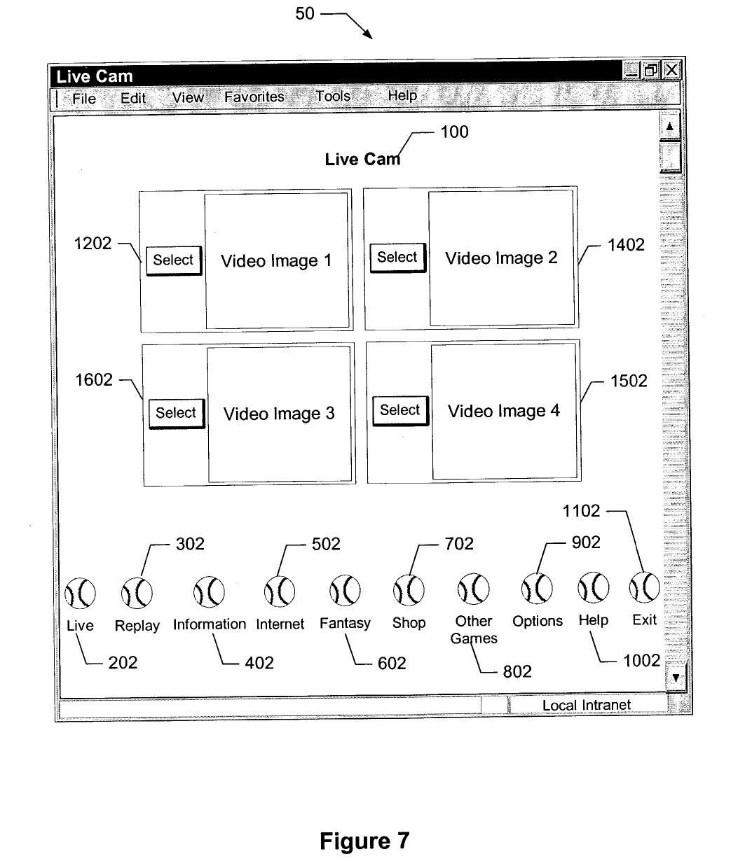

Referring to FIG. 7, such a main web page 50 is illustrated. Hypertext links 202, 302, 402, 502, 602, 702, 802, 902, 1002, 1102, shown as annotated baseballs in the case of a baseball venue toward the bottom of the page in this example, provide the user with navigation to other webpages that are available in this particular venue. Simultaneously displayed lower resolution video 1202, 1402, 1502 and 1602 can be displayed, and audio is presented from just one of the screens, initially (click to select audio). Users can view any one live video (and audio) full screen by selecting a nearby link button or by clicking somewhere over the surface of a given video display. Browser familiar, forward and back navigation is supported. The “Back” function takes the user from displaying the full-screen video feed, back to the above video, low resolution display screen. User navigation and operation could be intuitive. Users could not have to read a manual, talk to or call someone, or take a course to learn how to operate the access device or to navigate around the website.

The “Live” baseball icon 202 is highlighted in green on the image above to signify that it is the currently active service area. The “Replay” 302 baseball icon provides the user access to the main “Replay Menu”. The “Information” baseball icon 402 provides the user access to the “Main Information Menu”. The “Internet” baseball icon 502 provides the user access to a popular Internet search engine home page. The “Fantasy” baseball icon 602 provides the user access to a menu of fantasy sports games and related entertainment. The “Shop” baseball icon 702 provides the user access to the Main Shopping Menu. The “Other Games” baseball icon 802 provides the user access to a menu of television broadcasts of other available sports events news and entertainment. The “Options” baseball icon 902 provides the user access to a menu of service options. The “Help” baseball icon 1002 provides the user access to a menu of help and support tools. The “Exit” baseball icon 1102 provides the user a means by which to completely log off the service.

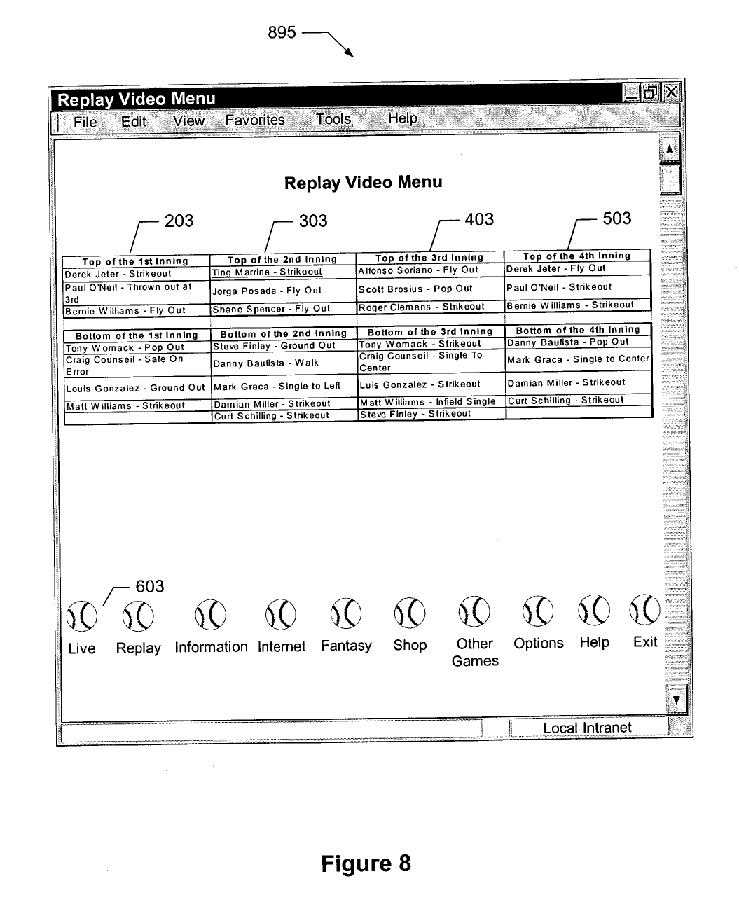

Referring to FIG. 8., a web page 895 illustrates that displayed when a user selects replay link 302. The first reply webpage shows a growing list of hypertext links (over time, as the game progresses) that allow the user to view a given replay. A static, simplistic example of what a typical replay video screen might look like in a football venue can be organized by quarters, or as illustrated for baseball, organized by innings in columns 203, 303, 403, 503. Under each column heading are a series of hotlinks to identify plays according to ball possession down and yardage required for first down as well as a two to three word summary of the action contained in the replay. To view a replay, the end user would tap his stylus on the desired hotlink. The navigation buttons 603 at the bottom of web page 895 are identical to those displayed in FIG. 7 above. The replay button is highlighted in green as it is the active one.

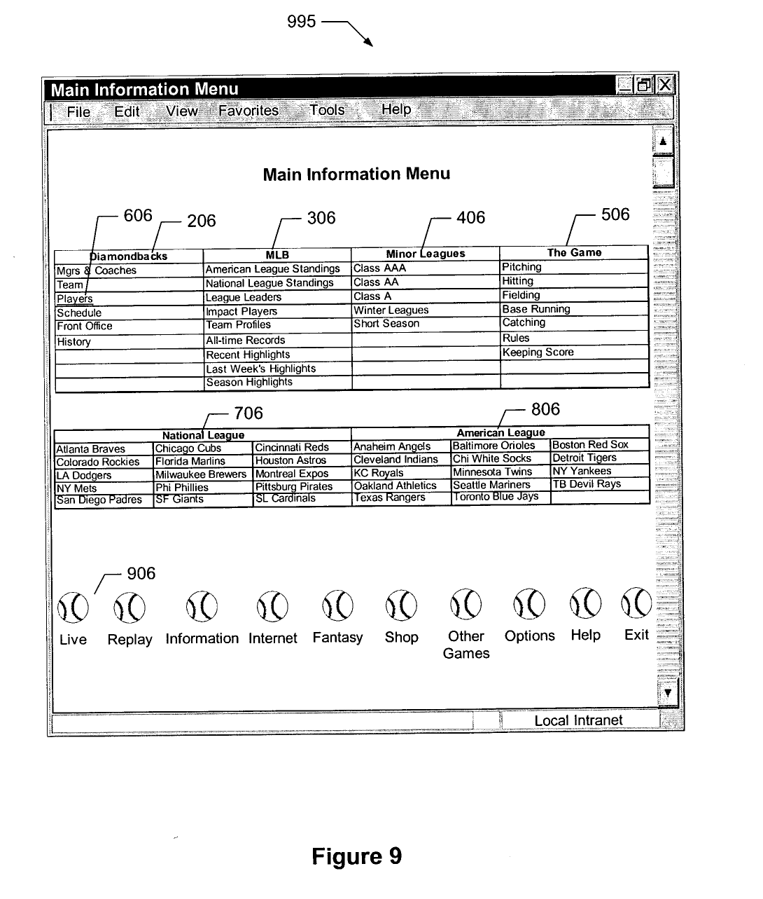

Referring to FIG. 9., a main menu webpage 995 is illustrated. This menu is comprised of lists of hotlinks that provide access to various sorts of multimedia content organized by category, including the “Diamonbacks” 206, “MLB” (Major League Baseball) 306, “Minor Leagues” 406 “The Game” (of Baseball) 506, “National League” 706, American League” 806. Under the “Diamondbacks” 206 category, the “Players” 606 hotlink is highlighted in red as it is the one being selected by the end user in this example. The row of baseball icon navigation buttons 906 at the bottom of main menu 995 are identical to those displayed in FIG. 3 above. In main menu 995, the “Information” button 402 is highlighted in green as it is the active one.

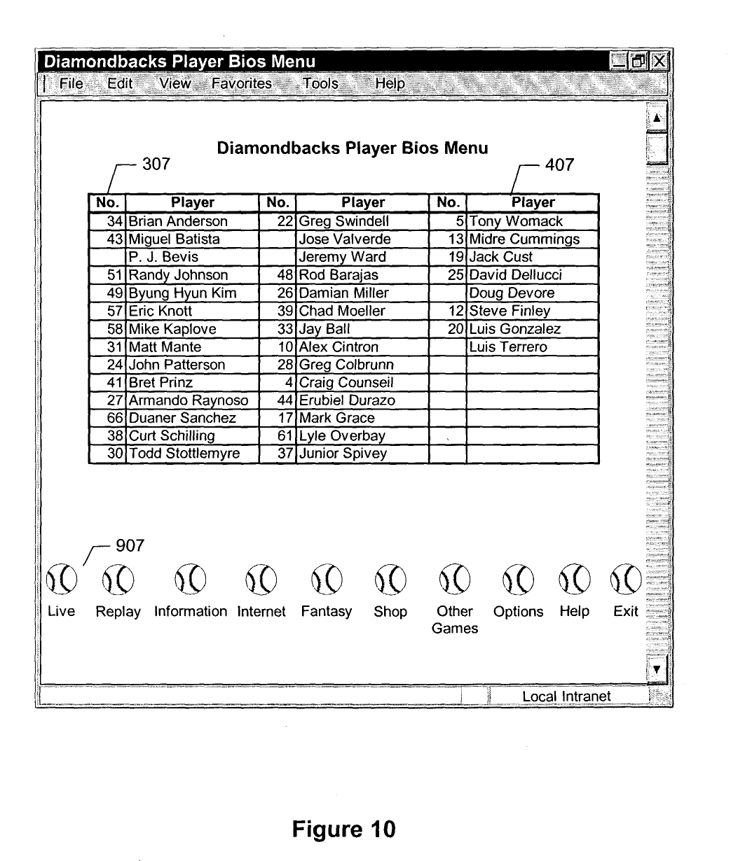

Referring now to FIG. 10, assuming the user has selected the Diamondbacks Player Bios 606 item in the previous main menu webpage 995, a new webpage is presented. Each valid player number 307 and player name 407 represents a hypertext link, from which the user may select information about a specific player, such as no. 38, Curt Schilling, from the list. The row of baseball icon navigation buttons 907 at the bottom of FIG. 10 are identical to those displayed in FIG. 3 above.

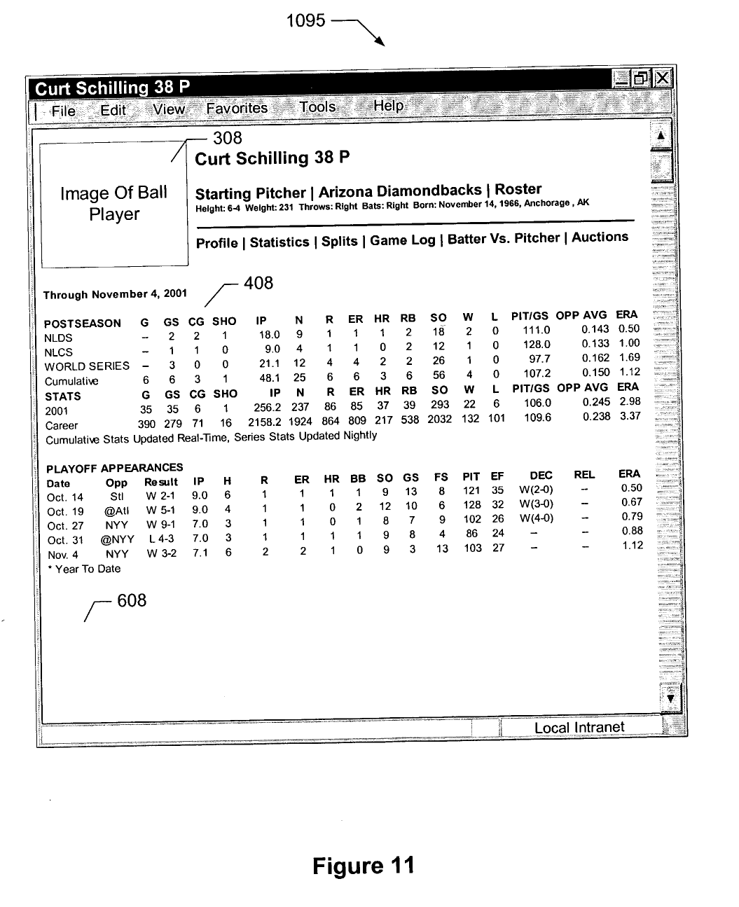

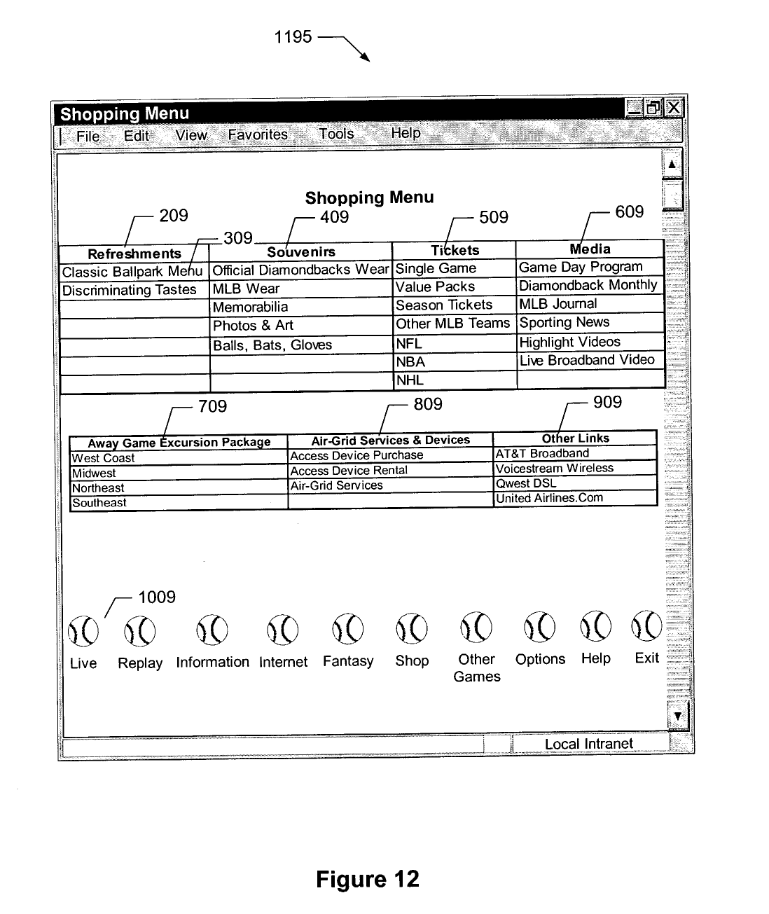

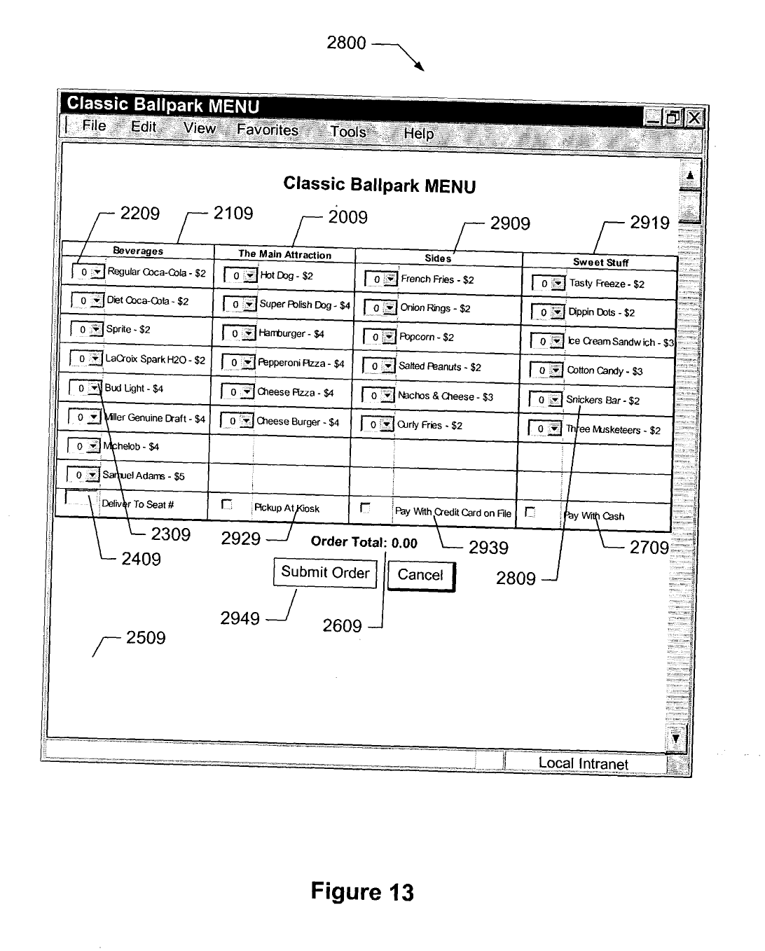

Assuming the user selects the Curt Schilling link in FIG. 10, they are taken to a statistics page 1095 for the selected player as illustrated in FIG. 11. Below Schilling's, name, number and position is displayed his thumbnail picture 308, which in some embodiments can be a video clip of the player or a still picture. Two tables of recent statistics about Curt Schilling are displayed in the middle of the page 408. Below the thumbnail profile is listed a series of hotlinks to more detailed information about this player's background, statistics and performance versus various opposing batters. The row of baseball icon navigation buttons 608 displayed at the bottom of FIG. 11 are identical to those described in FIG. 3 above. In FIG. 6 the “Information” button is highlighted in green to indicate that this is the active one.

Where a user selects the hypertext link, “Shop” 702 from any webpage in this system, a shopping menu page 1195 is presented. The menu is organized into a series of major shopping categories headings including “Refreshments” 209, “Souvenirs” 409, “Tickets” 509, “Media” 609, “Away Game Excursion Packages” 709, “Air-Grid Services & Devices” 809, and “Other” 909. Under each shopping heading is a series of links that provide access to associated e-commerce transaction services, such as “Classic Ballpark Menu” 309. At the bottom of shopping menu 1195 is a row of navigation buttons or a link group 1009, identical to those in FIG. 3. On shopping menu 1195, the “Shop” button is highlighted in green as it is the active one.

FIG. 8 above displays the “Classic Ballpark Menu” 2800. The menu presents the stadium concessionaire's menu of refreshments organized into major categories, including “Beverages” 2109, “The Main Attraction” 2009, “Sides” 2909, and “Sweet Stuff” 2919. Below each category is a list of relevant menu selections such as “Regular Coke” 2209, with boxes next to each selection into which the end user will enter his order quantity by tapping the box the corresponding number of times. As the order is placed, the “Order Total” box 2609 will display the items selected and the total cost of each. Upon selecting items and quantities of each, the end user indicates his choice of having the order delivered to his seat by entering the his seat number in the relevant box 2409 or of collecting the order himself at the concessions kiosk by ticking the appropriate box 2929. Then he indicates that he will pay for the order using the credit card on file 2939, or by paying with cash 2709 by ticking the appropriate box. Finally the end user submits or cancels the order by tapping the appropriate button 2949. The row of navigation buttons 2509 at the bottom of menu 2800 are identical to those in FIG. 3.

It is expected that the sources of most of this material will come from the ball club, arena owner, and the like. For example, assuming the user selects Players on the Diamondbacks category, the following webpage example might be displayed:

A short video clip is played in a loop, when this webpage is served to a user. AirGrid Networks will require source video and text from various ballclubs and/or leagues, and will require ongoing web development to customize websites for each ballclub (customer) venue.

It can be possible for subscribers to view a specific on-line product catalog of concessionaires' products and arrange for either delivery to a user's seat/suite, or kiosk pickup.

Below is an example of two web pages that could implement these services:

An e-commerce ordering process captures subscriber's on-line requests, tally an order, capture funds from a credit card or identify where a cash transaction is to occur, notify the concession provider of the pending transaction, and provide means to complete a given transaction. Regarding refreshments, for example, the classic ballpark menu, the following web page could be displayed:

It is preferred that a reliable and well-known e-commerce product catalog and financial clearing software package be acquired and integrated into the overall system. It is desirable that the product catalog be easily customized to accommodate various customers (ballclubs) and their concession providers.

Advertising

It can be possible to provide at least two forms of advertising: 1.) Video clip insertion/trailer adds, and hypertext link advertising. Video clip insertion has the same effect as regular TV broadcasting: a primary video is played, then an advertisement video clip is next shown, followed by a return to the main video session. At some point in the future it may be desirable to offer multiple tiers of services packages. It is expected that video clips will be provided to Air-Grid by the ballclubs' primary advertising sponsors.

Multiple price plans might also be provided for a given service. For example, for service package XYZ, two price plans may be offered. One, higher priced, that has no advertisements. A second price plan for the same XYZ package could be lower priced, that contains a significant amount of advertisements.

Each subscriber can have public Internet access via a protected firewall and network address translation. No particular bandwidth or service level agreements will be required, except that at least 56 kbps bandwidth should be available per user. It is expected that one DS-1 (1.5 mbps) data rate will be adequate, per stadium.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A multi-media network implemented in a event venue, the multi-media network comprising:
one or more media inputs, wherein the media inputs provide information associated with the event venue;
an editing system communicably coupled to the one or more media inputs, wherein the editing system can manipulate the information received from the one or more media inputs;
a distribution system communicably coupled to the editing system; and
a portable access device communicably coupled to the distribution system.

2. The multi-media network of claim 1, wherein the one or more media inputs comprise one or more video images of an event ongoing in the event venue.

3. The multi-media network of claim 1, wherein the distribution system comprises a wireless network.

4. The multi-media network of claim 1, wherein a plurality of video streams are accessible from the distribution system via the portable access device.

5. The multi-media network of claim 1, wherein the distribution system is a network implemented within the event venue, and wherein the one or more media streams include at least two video and audio streams accessible to entities contracting with a sports franchise associated with the sporting arena.

6. The multi-media network of claim 1, wherein access to various information available via the distribution network is limited to a specific geographical area.

7. The multi-media network of claim 6, wherein the geographical area is defined by the grounds of the event venue.

8. The multi-media network of claim 1, wherein the editing system provides at least a one live video stream and at least one replay video stream.

9. The multi-media network of claim 8, wherein the replay video stream is provided via a server that stores the replay video stream.

10. The multi-media network of claim 8, wherein a user can select via the portable access device between the replay video stream and the live video stream.

11. A method for distributing content rights local to an event venue, the method comprising:
receiving a content stream;
formatting the content stream into a first accessible format and a second accessible format; and
providing access to the first and the second accessible formats via a portable access device maintained local to the event venue.

12. The method of claim 11, wherein the content rights are rights remaining after distribution rights external to the event venue have been sold.

13. The method of claim 11, wherein formatting the content stream comprises formatting the content stream into one or more formats selected from the group consisting of: video format, audio format, graphics format, picture format, and text format.

14. The method of claim 11, wherein the first accessible format is a video replay, and wherein the second accessible format is a live video.

15. The method of claim 11, the method further comprising:
providing a purchase option via the portable access device, wherein the purchase option provides a user an ability to purchase products associated with the event venue.

16. The method of claim 15, wherein the products are food items.

17. The method of claim 11, the method further comprising:
providing a plurality of replay options on the portable access device;
receiving a selection of one of the plurality of replay options; and
providing a replay video associated with the replay option to the portable access device.

18. A method for distributing content in a sporting arena, the method comprising:
receiving content from a plurality of sources in the sporting arena;
editing at least one of the plurality of sources, wherein a live stream and a replay stream are created;
presenting a first selection associated with the live stream and a second selection associated with the replay stream on a portable access device;
receiving an indication of the replay stream; and
providing the replay stream to the portable access device.

19. The method of claim 18, the method further comprising:
providing a shopping interface via the portable access device, wherein a user can order goods available at the sporting arena.

20. The method of claim 18, the method further comprising:
predicting which content from the plurality of sources to provide as a multicast verses a unicast to the portable access device, wherein the prediction is based at least in part on a quantity of selections received from a plurality of portable access devices.
